(19) United States
(12) Patent Application Publication
(10) Pub. No.: US 2021/0224349 A1
(43) Pub. Date: Jul. 22, 2021

(54) METHOD AND APPARATUS FOR ANALYZING DATA FLOW, DEVICE, AND MEDIUM

(71) Applicant: BEIJING INTERNETWARE LIMITED COMPANY, Beijing (CN)

(72) Inventors: Ying Zhang, Beijing (CN); Xiaomin Zhu, Beijing (CN); Xing Su, Beijing (CN); Gang Huang, Beijing (CN); Wei Yao, Beijing (CN)

(21) Appl. No.: 16/314,148

(22) PCT Filed: Apr. 12, 2018
(86) PCT No.: PCT/CN2018/082822

§ 371 Date: Dec. 28, 2018

(30) Foreign Application Priority Data
Sep. 25, 2017 (CN) CN 201710874992.4

(51) Int. Cl. G06F 16/957; G06F 16/958; G06F 9/30

(52) U.S. Cl. CPC G06F 16/9577; G06F 9/3005; G06F 16/958

(57) ABSTRACT

Disclosed are a method and an apparatus for analyzing a data flow, a device, and a medium, relating to data processing techniques. The method includes: acquiring, from a resource file corresponding to a web application to be analyzed, javascript code; determining code logic of the javascript code; inserting a probe into the javascript code according to the code logic, wherein the probe is a piece of code; running the resource file with the inserted probe, acquiring, according to the probe, data in a process that the web application implements the code logic through a browser, and recording the data; and analyzing the web application based on the recorded data.

### TECHNICAL FIELD

The present disclosure relates to data processing techniques, for example, to a method and an apparatus for analyzing a data flow, a device, and a medium.

### BACKGROUND

Nowadays, World Wide Web (Web) applications with a large-scale and complex front-end have become more and more popular. For these complex Web applications, parts of the business and data processing logic are realized through browser, so it is not possible to extract all the runtime data of the Web application directly from the Webpages returned by the server. For example, the view of the Web application is obtained by rendering the corresponding JavaScript code through the JavaScript engine in the browser, and the rendering data cannot be directly extracted from the Webpages returned by the server.

Therefore, in the process of related data flow processing, data flow analysis cannot be performed normally due to lack of integrity of the acquired data.

### SUMMARY

An embodiment of the present disclosure provides a method and an apparatus for analyzing a data flow, a device, and a medium, so as to implement data acquisition and analysis of a Web application whose parts of code logic are implemented through browser.

An embodiment of the disclosure provides a method for analyzing a data flow, which is applied to the browser side, and the method includes:

acquiring, from a resource file corresponding to a web application to be analyzed, javascript code;

determining code logic of the javascript code;

inserting a probe into the javascript code according to the code logic, the probe is a piece of code;

running the resource file with the inserted probe, acquiring, according to the probe, data in a process that the web application implements the code logic through a browser, and recording the data; and

analyzing the web application based on the recorded data.

Optionally, the acquiring, according to the probe, the data in the process that the web application implements the code logic through the browser, and recording the data, includes:

acquiring, based on preset analysis code in the browser and according to the probe, the data in the process that the web application implements the code logic through the browser; and

normalizing the data and storing the normalized data.

Optionally, the analyzing the web application based on the recorded data includes:

reading the recorded data;

reconstructing, according to a data object, generation time of the data object, and an input of the data object and an output of the data object in the recorded data, an entire event tree; and

determining, based on the event tree and a data object of interest as acquired, an execution state of the data object of interest in execution of the web application; the execution state includes a state of the data object of interest in performing the browser mechanism, the data object of interest is any data object triggered during the execution of the web application, and the browser mechanism including any one of the following: data cookies stored on a local user device, asynchronous javascript, extensible markup language (XML), web storage, and document object model (DOM) event mechanism.

Optionally, the determining, based on the event tree and the data object of interest as acquired, the execution state of the data object of interest in the execution of the Web application includes:

determining a node corresponding to the data object of interest in the event tree, and taking the node as a current node;

traversing forward and backward on the basis of the current node, based on the event tree, a data object corresponding to a node which has at least one of a direct relationship and indirect relationship with the current node; and

determining a reachable set of the data object of interest based on the data object, the reachable set is associated data objects including the data object of interest.

Optionally, the determining, based on the event tree and the data object of interest as acquired, the execution state of the data object of interest in the execution of the Web application includes:

acquiring data of interest;

determining, according to the data of interest, a node corresponding to the data object of interest in which the data of interest is located; and

determining, based on the node and the event tree, an execution state of the data of interest in the execution of the web application.

Optionally, the determining the code logic of the javascript code and inserting the probe into the javascript code according to the code logic, includes:

determining whether the resource file corresponding to the javascript code is a preset resource file to be ignored;

if not, determining the code logic of the javascript code; and

inserting the probe into the javascript code according to the code logic;

the preset resource file to be ignored is a resource file into which the probe does not need to be inserted.

Optionally, the acquiring, from the resource file corresponding to the web application to be analyzed, the javascript code, includes:

acquiring the resource file, related to the web application to be analyzed and returned by a server corresponding to the web application to be analyzed;

determining the type of the resource file;

acquire code in the resource file, if the resource file is a javascript file; and

determining embedded javascript code according to a preset identifier, if the resource file is a hypertext markup language (HTML) file.

The embodiment of the disclosure further provides an apparatus for analyzing a data flow, applied to a browser side, including:

a code acquisition module, configured to acquire javascript code in a resource file corresponding to a web application to be analyzed;

a logic determining module, configured to determine code logic of the javascript code, and insert a probe into the javascript code according to the code logic, the probe is a piece of code;

a data acquisition module, configured to run the resource file with the inserted probe, acquire, according to the probe, data in a process that the web application implements the code logic through a browser, and record the data; and

a data analysis module, configured to analyze the web application based on the recorded data.

The embodiment of the present disclosure further provides an apparatus, which includes: a device, which includes:

one or more processors;

the browser as described above; and

a storage device, configured to store one or more programs;

the one or more programs when executed by the one or more processors cause the one or more processors to perform the method for analyzing the data flow as described above The embodiment of the present disclosure also provides a computer storage medium, which stores computer programs that when executed by a processor perform the method for analyzing the data flow as described above.

In the embodiment of the present disclosure, probes are inserted into the JavaScript code of the Web application to be analyzed to acquire the runtime data, which is then used to analyze the Web application. Because the probes are inserted into the source code, this method can be applied to browsers with different characteristics. Moreover, since the runtime data of the corresponding code logic is automatically acquired through the inserted probes, the inefficiency and time-consuming of using the conventional inserting breakpoints, monitoring variables, etc. to track and debug data are solved.

### BRIEF DESCRIPTION OF DRAWINGS

FIG. 1 is a flowchart of a method for analyzing a data flow according to an embodiment of the present disclosure;

FIG. 2 is a flowchart of a method for analyzing a data flow according to another embodiment;

FIG. 3 is a flowchart of a data flow acquisition part in another method for analyzing a data flow according to an embodiment;

FIG. 4 is a flowchart of a data flow analysis part in another method for analyzing a data flow provided by an embodiment;

FIG. 5 is a schematic structural diagram of a data flow analysis apparatus according to an embodiment of the present disclosure;

FIG. 6 is a schematic structural diagram of an apparatus according to an embodiment of the present disclosure.

### DETAILED DESCRIPTION

At present, the data flow analysis scheme is mainly divided into the following two types, and has the following defects:

The first scheme uses some methods in the field of program analysis and constraint solving to perform unified static analysis or dynamic analysis on JavaScript code. The high dynamic nature of JavaScript code makes static program analysis techniques such as static program slicing and side-effect analysis techniques difficult to effectively apply to the analysis of JavaScript code. Because different browsers have different characteristics, unified dynamic analysis methods cannot apply to different browsers with various characteristics, which leads to limitations of the analysis of the program.

The second option is for developers to use the front-end debugging tools such as the Google Developer Toolkit or Firebug in the browser to track and debug the Web application. However, using traditional methods of inserting breakpoints, monitoring variables, etc. to track the flow of data is very inefficient and time-consuming.

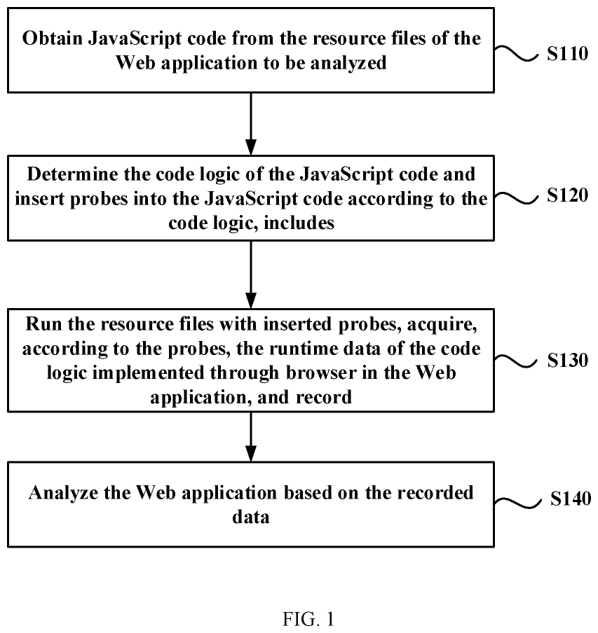

FIG. 1 is a flowchart of a method for analyzing a data flow according to an embodiment of the present disclosure. This embodiment is applicable to the case of analyzing data produced by the code logic which is implemented by means of the browser. The method is applied to the browser side and can be executed by a data flow analysis device, and the device can be implemented by means of software or hardware. Referring to FIG. 1, a method for analyzing a data flow provided by this embodiment includes:

In S110, the JavaScript code in the resource files corresponding to the Web application to be analyzed is obtained.

In an embodiment, the process of acquiring the JavaScript code in the resource files corresponding to the Web application to be analyzed may include:

obtaining a uniform resource identifier of the Web application to be analyzed determined by the user;

sending a request to the server corresponding to the Web application according to the unified resource identifier;

receiving Webpage data returned by the server;

parsing the Webpage data, and requesting related resource files according to the parsing result;

receiving the resource files returned by the server;

determining the type of the resource file, if the resource file is a JavaScript file, obtain the code from it; and

if the resource file is a Hyper Text Markup Language (HTML) file, the embedded JavaScript code can be obtained according to the preset identifier.

In S120, code logic of the JavaScript code is analyzed, and probes are inserted into the JavaScript code according to the code logic.

The probe may be a piece of code for checking the execution of the JavaScript code, the change of the variable, and the like. The code logic can be assignment logic, loop logic, judgment logic, etc. The code logic can be judged by the corresponding function or symbol. For example, if the symbol of “=” is recognized, it is judged as assignment logic; if “if” is recognized, it is judged as judgment logic.

Optionally, in order to improve coverage, the judgement of the code logic and the insertion of probes can be performed on the JavaScript code in all resources. This enables coverage of all code logic, which in turn improves the integrity of data analysis.

In an embodiment, determining code logic of the JavaScript code, and inserting probes into the JavaScript code according to the code logic, include:

determining whether the resource file corresponding to the JavaScript code is a preset resource file to be ignored, and if not, determine code logic of the JavaScript code, and insert probes into the JavaScript code according to the code logic.

Optionally, the preset resource files to be ignored may be resource files that do not need to be inserted with probes. For example, it may be a preset resource file that does not care, or a resource file that does not help the analysis of the Web application, or a resource file whose data logic is already known. After determining that the resource file corresponding to the JavaScript code is a preset resource file to be ignored, the resource file may be skipped and the judgment of other resource files may be continued.

By judging whether the resource file corresponding to the JavaScript code is a preset resource file to be ignored, the effect may be achieved: because the logic of the data in the ignoring resource file is not concerned, the judgement of the code logic and the insertion of the probes do not perform. This saves the time of the judgement of the code logic of the JavaScript code and the probe insertion.

In S130, running the resource files with inserted probes, acquiring, according to the probes, the data of the logic process implemented through browser operations in the Web application, and recording;

In an embodiment, the data of the logic process implemented through browser operations in the Web application acquired according to the probes, may be data in the runtime of the code logic, and the data may include functions' name, methods' name, parameters passed in the invocation and the statements in the callback function.

In S140, the Web application is analyzed based on the recorded data.

In an embodiment, the runtime data of the code logic which is implemented through browser can be used to analyze the data processing logic executed in the browser end.

The method for analyzing the data flow provided by the embodiment of the present disclosure, acquires the runtime data, which is then used to analyze the Web application, through inserting probes into the JavaScript code of the Web application to be analyzed to. Because the probes are inserted into the source code, this method can be applied to browsers with different characteristics. Moreover, since the runtime data of the corresponding code logic is automatically acquired through the inserted probes, the inefficiency and time-consuming of using the conventional insertion breakpoint, monitoring variables, etc. to track and debug data is solved.

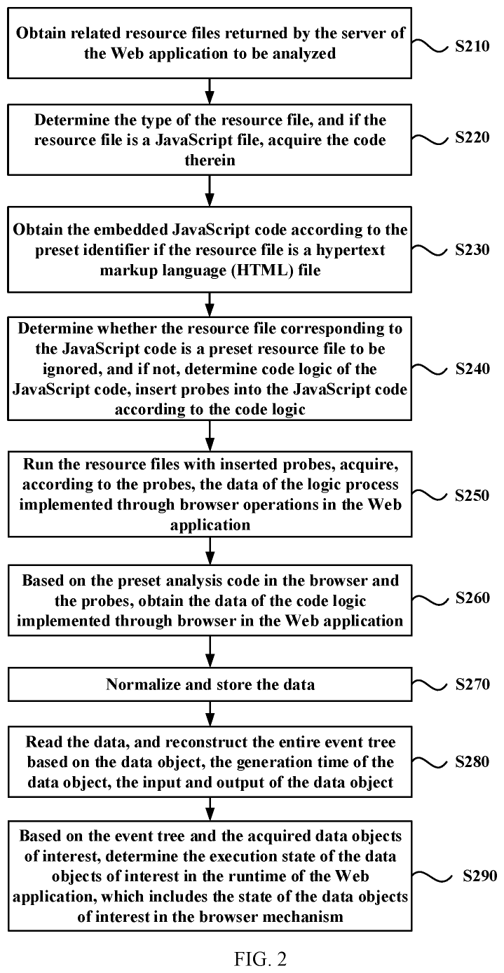

FIG. 2 is a flowchart of a method for analyzing a data flow according to an embodiment of the present disclosure. Referring to FIG. 2, the method for analyzing the data flow provided in this embodiment includes:

In S210, obtaining related resource files returned by the server of the Web application to be analyzed;

In S220, determining the type of the resource file, and if the resource file is a JavaScript file, acquire the code therein;

In S230, if the resource file is a hypertext markup language (HTML) file, obtain the embedded JavaScript code according to the preset identifier.

In S240, determining whether the resource file corresponding to the JavaScript code is a preset resource file to be ignored, and if not, determining code logic of the JavaScript code, inserting probes into the JavaScript code according to the code logic.

In S250, running the resource files with inserted probes, acquiring, according to the probes, the data of the logic process implemented through browser operations in the Web application

In S260, based on the preset analysis code in the browser and the probes, obtaining the data of the code logic implemented through browser in the Web application

The above data includes user's operation events and its corresponding Document Object Model (DOM) tree nodes. The preset analysis code can be set as needed, which is not limited in this embodiment.

In S270, the data is normalized and stored.

Among them, normalization is to convert data of different formats into a unified data format.

In S280, the data is read, and the entire event tree is reconstructed based on the data object, the generation time of the data object, the input and output of the data object.

In an embodiment, through the input and output of the data object, the data source and the data direction can be associated, and the execution flow of the data can be determined by the data object's generation time, and the entire event tree can be reconstructed according to the data direction and the data execution process.

In S290, based on the event tree and the acquired data objects of interest, determining the execution state of the data objects of interest in the runtime of the Web application. The execution state includes the state of the data objects of interest in the browser mechanism.

The data objects of interest is any data objects triggered during the execution of the Web application, and the browser mechanism including any one of the following: the cookies stored on the local device, asynchronous JavaScript, Extensible Markup Language (XML), Web Storage, and DOM event mechanism.

In an embodiment, based on the event tree and the acquired data objects of interest, determining the execution state of the data objects of interest in the runtime of the Web application, includes:

determining a node corresponding to the data object of interest in the event tree, and letting the node as the current node;

determining, based on the event tree and the current node, traversing forward and backward the data objects whose related node has direct or indirect relationship with the current node;

determining the reachable set of the data objects of interest based on the data objects, the reachable set is an associated data object including the data objects of interest.

The reachable set is a series of associated data objects including the data object of interest. The reachable set can determine the source and destination of the data object of interest. According to this, it is possible to analyze the data object of interest in the Web application to be analyzed.

In an embodiment, based on the event tree and the acquired data objects of interest, determining the execution state of the data objects of interest in the runtime of the Web application, includes:

obtaining the data of interest;

locating, according to the data of interest, the nodes corresponding to the data objects of interest; and

determining, based on the node and the event tree, the execution state of the data of interest in the runtime of the Web application.

The data of interest may be a certain parameter, which can be obtained through user input. The execution state of the data of interest in the runtime of the Web application may specifically be an object that the data of interest passes, an operation performed, a function called, and the like during the runtime of the Web application. According to this, it is possible to analyze the data of interest in the Web application.

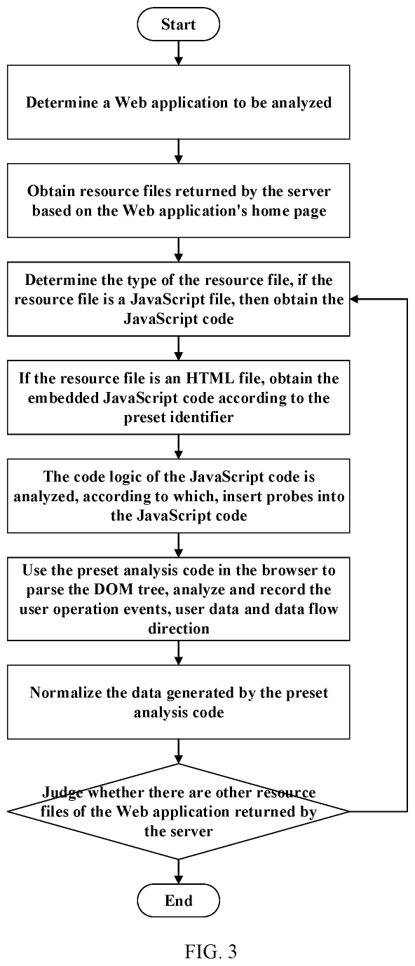

In practical applications, referring to FIG. 3, the method for analyzing the data flow may also be described as: determining a Web application to be analyzed; obtaining resource files returned by the server based on the Web application's home page; determining the type of the resource file, if the resource file is a JavaScript file, then the JavaScript code is obtained; if the resource file is an HTML file, the embedded JavaScript code is obtained according to the preset identifier; the code logic of the JavaScript code is analyzed, according to which, probes are inserted into the JavaScript code; use the preset analysis code in the browser to parse the DOM tree, analyze and record the user operation events, user data and data flow direction; normalize the data generated by the preset analysis code; if there are other resources of the Web application returned by the server, then return to continue execution. If the resource file is a JavaScript file, the step of acquiring the JavaScript code is performed.

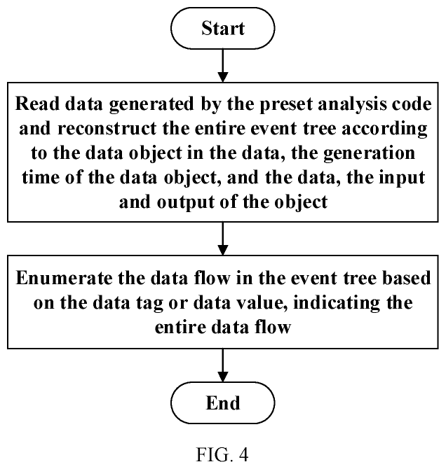

Referring to FIG. 4, the analysis process of the Web application to be analyzed by using the data generated by the preset analysis code may be described as: reading data generated by the preset analysis code; according to the data object in the data, the generation time of the data object, and the input and output of the data object, reconstructing the entire event tree; enumerating the data flow in the event tree based on the data tag or data value, and indicating the entire data flow. Thus the analysis of the data flow in the Web application to be analyzed is implemented.

The method for analyzing the data flow provided by the implementation of the disclosure can realize the custom analysis of the data acquired by the probes through the preset analysis code in the browser; and at the same time, reconstruct the entire event tree by using the data acquired by the probes. An overall analysis of the event of interest or data of interest can be achieved based on the entire event tree.

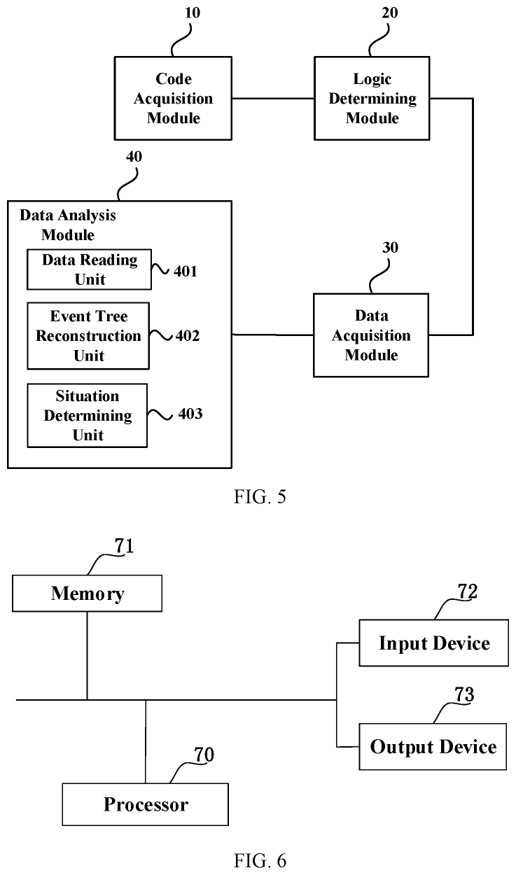

FIG. 5 is a schematic structural diagram of a data flow analysis apparatus according to an embodiment of the present disclosure. Referring to FIG. 5, the data flow analysis apparatus provided in this embodiment includes: a code acquiring module 10, a logic determining module 20, a data acquiring module 30, and a data analyzing module 40.

The code acquisition module 10, configured to obtain the JavaScript code in the resource files corresponding to the Web application to be analyzed;

The logic determining module 20, configured to determine the code logic of the JavaScript code, and to insert probes into the JavaScript code according to the code logic. Each of the probes is a piece of code;

The data acquisition module 30, configured to run the resource files with probes inserted, obtain the data in the code logic implemented through browser operations according to the probes, and record the data;

The data analysis module 40, configured to analyze the Web application based on the recorded data.

Optionally, the data obtaining acquisition module 30 is specifically configured to:

obtain, according to the preset analysis code in the browser, the data in the code logic process which is implemented through browser in the Web application; normalize the data and store it.

Optionally, the data analysis module 40 includes a data reading unit 401, event tree reconstruction unit 402, and a situation determining unit 403.

The data reading unit 401 is configured to read the recorded data.

The event tree reconstruction unit 402 is configured to reconstruct an entire event tree according to the data object, the generation time of the data object, the input and output of the data object.

The situation determining unit 403 is configured to: determine the execution state of the data objects of interest in the runtime of the Web application based on the event tree and the acquired data objects of interest. The execution state includes the state of the data objects of interest in the browser mechanism. The data objects of interest is any data objects triggered during the execution of the Web application, and the browser mechanism including any one of the following: the cookies stored on the local device, asynchronous JavaScript, Extensible Markup Language (XML), Web Storage, and DOM event mechanism.

Optionally, the situation determining unit 403 is specifically configured to:

determine the node corresponding to the data object of interest in the event tree, and letting the node as the current node;

determine, based on the event tree and the current node, traversing forward and backward the data objects whose related node has direct or indirect relationship with the current node; and

determine the reachable set of the data objects of interest based on the data objects, where the reachable set is an associated data object including the data objects of interest.

Optionally, the situation determining unit 403 is specifically configured to:

obtain the data of interest; Locate, according to the data of interest, the nodes corresponding to the data objects of interest; Determining, based on the node and the event tree, the execution state of the data of interest in the runtime of the Web application.

Optionally, the logic determining module 20 is specifically configured to:

determine whether the resource file corresponding to the JavaScript code is a preset resource file to be ignored, and if not, determining code logic of the JavaScript code, inserting probes into the JavaScript code according to the code logic. The preset resource files to be ignored are resource files that do not need to be inserted with probes.

Optionally, the code obtaining module 10 is specifically configured to:

obtain related resource files returned by the server corresponding to the Web application to be analyzed;

determine a type of the resource file, and if the resource file is a JavaScript file, acquire the code therein; and

if the resource file is a hypertext markup language (HTML) file, obtain the embedded JavaScript code according to the preset identifier.

The data flow analysis device provided by the embodiment of the present disclosure, inserts probes into the JavaScript code of the Web application to be analyzed to acquire the runtime data, which is then used to analyze the Web application. Because the probes are inserted into the source code, this method can be applied to browsers with different characteristics. Moreover, since the runtime data of the corresponding code logic is automatically acquired through the inserted probes, the inefficiency and time-consuming of using the conventional insertion breakpoint, monitoring variables, etc. to track and debug data is solved.

FIG. 6 is a schematic structural diagram of an apparatus according to an embodiment of the present disclosure. As shown in FIG. 6, the apparatus includes a processor 70, a memory 71, an input device 72, and an output device 73. The output device 73 includes any of the browsers mentioned in the embodiments of the present disclosure; the number of processors 70 in the device may be one or more, and one processor 70 is taken as an example in FIG. 6; the processor 70, the memory 71, the input device 72, and the output device 73 can be connected by bus or other means, and the bus is taken as an example in FIG. 6.

The memory 71 is used as a computer readable storage medium for storing software programs, computer executable programs, and modules, such as the program instructions or modules corresponding to the method for analyzing the data flow in the embodiment of the present disclosure (for example, the code acquisition module 10, the logic determination module 20, the data acquisition module 30, and the data analysis module 40 included in the data flow analysis device). The processor 70 executes various functional applications and data processing of the device by executing software programs, instructions, and modules stored in the memory 71, which implements the above-described method for analyzing a data flow.

The memory 71 may mainly include a program storage area and a data storage area, where the program storage area may store an operating system, an application required for at least one function; the data storage area may store data created during the usage of the device, and the like. Further, the memory 71 may include a high speed random access memory, and may also include a nonvolatile memory such as magnetic disk storage device, flash memory device, or other nonvolatile solid state storage device. In some examples, memory 71 may further include memory remotely located relative to processor 70, which may be connected to the device over a network. Examples of such networks include, but are not limited to, the Internet, intranets, local area networks, mobile communication networks, and combinations thereof.

The device, provided by the embodiment of the present disclosure, inserts probes into the JavaScript code of the Web application to be analyzed to acquire the runtime data, which is then used to analyze the Web application. Because the probes are inserted into the source code, this method can be applied to browsers with different characteristics. Moreover, since the runtime data of the corresponding code logic is automatically acquired through the inserted probes, the inefficiency and time-consuming of using the conventional insertion breakpoint, monitoring variables, etc. to track and debug data is solved.

Embodiments of the present disclosure also provide a storage medium containing computer executable instructions for performing the method for analyzing the data flow when executed by a computer processor, and the method includes:

obtaining JavaScript code from the resource files corresponding to the Web application to be analyzed;

determining code logic of the JavaScript code, inserting probes into the JavaScript code according to the code logic. Each of the probes is a piece of code;

running the resource files with inserted probes, acquiring, according to the probes, the data of the logic process implemented through browser operations in the Web application, and recording; and

analyzing the Web application based on the recorded data.

Of course, as for the storage medium containing computer executable instructions provided by the embodiment of the present disclosure, the computer executable instructions are not only limited to the methods as described above, but also any method for analyzing a data flows provided by any embodiments of the present disclosure.

Through the above description of the embodiments, those skilled in the art can clearly understand that the present disclosure can be implemented by software and necessary general hardware, and can also be implemented by hardware, but in many cases, the former is a better implementation. Based on such understanding, the technical solution of the present disclosure, which is essential or contributes to the prior art, may be embodied in the form of a software product, which may be stored in a computer readable storage medium, such as a floppy disk of a computer, Read-Only Memory (ROM), Random Access Memory (RAM), Flash (FLASH), hard disk or optical disk, etc., including a number of instructions to make a computer device (may be a personal computer, a server, or network device, etc.) performs the methods described in various embodiments of the present disclosure.

It should be noted that, in the foregoing embodiment of the search apparatus, each unit and module included is only divided according to functional logic, but is not limited to the above division, as long as the corresponding function can be implemented; the specific names of the units are also for convenience of distinguishing from each other and are not intended to limit the scope of the present disclosure.

### INDUSTRIAL APPLICABILITY

The embodiment of the disclosure is applicable to browsers with different characteristics, and solves the inefficiency and time-consuming of the traditional methods of inserting breakpoints, monitoring variables and the like to track and debugging data, and realizes acquisition and analysis of data in the code logic implemented through browser in the Web application.

What is claimed is:

1. A method for analyzing a data flow, which is applied to a browser side, comprising:
acquiring, from a resource file corresponding to a web application to be analyzed, javascript code;
determining code logic of the javascript code;
inserting a probe into the javascript code according to the code logic, wherein the probe is a piece of code;
running the resource file with the inserted probe, acquiring, according to the probe, data in a process that the web application implements the code logic through a browser, and recording the data; and
analyzing the web application based on the recorded data.

2. The method according to claim 1, wherein the acquiring, according to the probe, the data in the process that the web application implements the code logic through the browser, and recording the data, comprises:
acquiring, based on preset analysis code in the browser and according to the probe, the data in the process that the web application implements the code logic through the browser; and
normalizing the data and storing the normalized data.

3. The method according to claim 1, wherein the analyzing the web application based on the recorded data comprises:
reading the recorded data;
reconstructing, according to a data object, generation time of the data object, and an input of the data object and an output of the data object in the recorded data, an entire event tree; and
determining, based on the event tree and a data object of interest as acquired, an execution state of the data object of interest in execution of the web application; wherein the execution state comprises a state of the data object of interest in performing the browser mechanism, the data object of interest is any data object triggered during the execution of the web application, and the browser mechanism comprising any one of the following: data cookies stored on a local user device, asynchronous javascript, extensible markup language (XML), web storage, and document object model (DOM)event mechanism.

4. The method according to claim 3, wherein the determining, based on the event tree and the data object of interest as acquired, the execution state of the data object of interest in the execution of the Web application comprises:
determining a node corresponding to the data object of interest in the event tree, and taking the node as a current node;
traversing forward and backward on the basis of the current node, based on the event tree, a data object corresponding to a node which has at least one of a direct relationship and indirect relationship with the current node; and
determining a reachable set of the data object of interest based on the data object, wherein the reachable set is associated data objects comprising the data object of interest.

5. The method according to claim 3, wherein the determining, based on the event tree and the data object of interest as acquired, the execution state of the data object of interest in the execution of the Web application comprises:
acquiring data of interest;
determining, according to the data of interest, a node corresponding to the data object of interest in which the data of interest is located; and
determining, based on the node and the event tree, an execution state of the data of interest in the execution of the web application.

6. The method according to claim 1, wherein the determining the code logic of the javascript code and inserting the probe into the javascript code according to the code logic, comprises:
determining whether the resource file corresponding to the javascript code is a preset resource file to be ignored;
if not, determining the code logic of the javascript code; and
inserting the probe into the javascript code according to the code logic;
wherein the preset resource file to be ignored is a resource file into which the probe does not need to be inserted.

7. The method according to claim 1, wherein the acquiring, from the resource file corresponding to the web application to be analyzed, the javascript code, comprises:
acquiring the resource file, related to the web application to be analyzed and returned by a server corresponding to the web application to be analyzed;
determining the type of the resource file;
acquire code in the resource file, if the resource file is a javascript file; and
determining embedded javascript code according to a preset identifier, if the resource file is a hypertext markup language (html) file.

8. An apparatus for analyzing a data flow, applied to a browser side, comprising:
a code acquisition module, configured to acquire javascript code in a resource file corresponding to a web application to be analyzed;
a logic determining module, configured to determine code logic of the javascript code, and insert a probe into the javascript code according to the code logic, wherein the probe is a piece of code;
a data acquisition module, configured to run the resource file with the inserted probe, acquire, according to the probe, data in a process that the web application implements the code logic through a browser, and record the data; and
a data analysis module, configured to analyze the web application based on the recorded data.

9. A device, which comprises:
at least one processor;
a browser; and
a storage device, configured to store at least one program;
wherein the at least one program when executed by the at least one processor cause the at least one processor to perform the following steps:
acquiring, from a resource file corresponding to a web application to be analyzed, javascript code;
determining code logic of the javascript code;
inserting a probe into the javascript code according to the code logic, wherein the probe is a piece of code;
running the resource file with the inserted probe, acquiring, according to the probe, data in a process that the web application implements the code logic through a browser, and recording the data; and
analyzing the web application based on the recorded data.

10. A computer storage medium, which stores computer programs that when executed by a processor perform the method according to claim 1.

11. The method according to claim 2, wherein the analyzing the web application based on the recorded data comprises:
reading the recorded data;
reconstructing, according to a data object, generation time of the data object, and an input of the data object and an output of the data object in the recorded data, an entire event tree; and
determining, based on the event tree and a data object of interest as acquired, an execution state of the data object of interest in execution of the web application; wherein the execution state comprises a state of the data object of interest in performing the browser mechanism, the data object of interest is any data object triggered during the execution of the web application, and the browser mechanism comprising any one of the following: data cookies stored on a local user device, asynchronous javascript, extensible markup language (XML), web storage, and document object model (DOM) event mechanism.

12. The method according to claim 2, wherein the determining the code logic of the javascript code and inserting the probe into the javascript code according to the code logic, comprises:
determining whether the resource file corresponding to the javascript code is a preset resource file to be ignored;
if not, determining the code logic of the javascript code; and
inserting the probe into the javascript code according to the code logic;
wherein the preset resource file to be ignored is a resource file into which the probe does not need to be inserted.

13. The method according to claim 3, wherein the determining the code logic of the javascript code and inserting the probe into the javascript code according to the code logic, comprises:
determining whether the resource file corresponding to the javascript code is a preset resource file to be ignored;
if not, determining the code logic of the javascript code; and
inserting the probe into the javascript code according to the code logic;
wherein the preset resource file to be ignored is a resource file into which the probe does not need to be inserted.

14. The method according to claim 4, wherein the determining the code logic of the javascript code and inserting the probe into the javascript code according to the code logic, comprises:
determining whether the resource file corresponding to the javascript code is a preset resource file to be ignored;
if not, determining the code logic of the javascript code; and
inserting the probe into the javascript code according to the code logic;
wherein the preset resource file to be ignored is a resource file into which the probe does not need to be inserted.

15. The method according to claim 5, wherein the determining the code logic of the javascript code and inserting the probe into the javascript code according to the code logic, comprises:
determining whether the resource file corresponding to the javascript code is a preset resource file to be ignored;
if not, determining the code logic of the javascript code; and
inserting the probe into the javascript code according to the code logic;
wherein the preset resource file to be ignored is a resource file into which the probe does not need to be inserted.

16. The method according to claim 2, wherein the acquiring, from the resource file corresponding to the web application to be analyzed, the javascript code, comprises:
acquiring the resource file, related to the web application to be analyzed and returned by a server corresponding to the web application to be analyzed;
determining the type of the resource file;
acquire code in the resource file, if the resource file is a javascript file; and
determining embedded javascript code according to a preset identifier, if the resource file is a hypertext markup language (html) file.

17. The method according to claim 3, wherein the acquiring, from the resource file corresponding to the web application to be analyzed, the javascript code, comprises:
acquiring the resource file, related to the web application to be analyzed and returned by a server corresponding to the web application to be analyzed;
determining the type of the resource file;
acquire code in the resource file, if the resource file is a javascript file; and
determining embedded javascript code according to a preset identifier, if the resource file is a hypertext markup language (html) file.

18. The method according to claim 4, wherein the acquiring, from the resource file corresponding to the web application to be analyzed, the javascript code, comprises:
acquiring the resource file, related to the web application to be analyzed and returned by a server corresponding to the web application to be analyzed;
determining the type of the resource file;
acquire code in the resource file, if the resource file is a javascript file; and
determining embedded javascript code according to a preset identifier, if the resource file is a hypertext markup language (html) file.

19. The method according to claim 5, wherein the acquiring, from the resource file corresponding to the web application to be analyzed, the javascript code, comprises:
acquiring the resource file, related to the web application to be analyzed and returned by a server corresponding to the web application to be analyzed;
determining the type of the resource file;
acquire code in the resource file, if the resource file is a javascript file; and
determining embedded javascript code according to a preset identifier, if the resource file is a hypertext markup language (html) file.

20. The method according to claim 6, wherein the acquiring, from the resource file corresponding to the web application to be analyzed, the javascript code, comprises:
acquiring the resource file, related to the web application to be analyzed and returned by a server corresponding to the web application to be analyzed;
determining the type of the resource file;
acquire code in the resource file, if the resource file is a javascript file; and
determining embedded javascript code according to a preset identifier, if the resource file is a hypertext markup language (html) file.
